(19) United States
(12) Patent Application Publication
(10) Pub. No.: US 2016/0136523 A1
(43) Pub. Date: May 19, 2016

(54) IMAGE GENERATING APPARATUS, PROGRAM, TERMINAL, AND IMAGE GENERATING SYSTEM

(71) Applicant: SQUARE ENIX HOLDINGS CO., LTD., Tokyo (JP)

(72) Inventor: Tomohito YANO, Tokyo (JP)

(73) Assignee: SQUARE ENIX HOLDINGS CO., LTD., Tokyo (JP)

(21) Appl. No.: 14/895,671

(22) PCT Filed: May 19, 2014
(86) PCT No.: PCT/JP2014/002628

§ 371 Date: Dec. 3, 2015

(30) Foreign Application Priority Data
Jun. 7, 2013 (JP) 2013-120554

(51) Int. Cl. A63F 13/52; A63F 13/825

(52) U.S. Cl. CPC A63F 13/52; A63F 13/825

(57) ABSTRACT

To provide means capable of transferring information to third parties easily.

An image generating apparatus (for example, server 10E) stores an image to be transmitted to a terminal controlled by a first player and positional information within a virtual space in which an avatar operated by the first player exists; receives a control signal for a terminal of a second player; updates, on the basis of the control signal, a state of a video game in the virtual space in which the avatar operated by the first player, the state of the video game being stored in the storage section (for example, Step S1203); generates an image to be transmitted to the terminal of the second player on the basis of the updated state of the video game (for example, Step S1204); and transmits data corresponding to the generated image to the terminal of the second player.

### FIELD OF THE INVENTION

At least one of embodiments relates to an image generating apparatus.

### BACKGROUND OF THE INVENTION

Heretofore, various kinds of image generating apparatuses are adopted in a distributed computer system such as a cloud gaming system.

In such image generating apparatuses, for example, there is one adopted in a system capable of referring to a text memo created by other user and arranged in a virtual space by causing a user's own avatar to move to a position on the virtual space on which the avatar is arranged.

### SUMMARY OF THE INVENTION

### Problems to be Solved by the Invention

As one of problems of the conventional system, there is one in which a user of the system has to carry out a complicated work to a certain extent in order to cause other user to browse data created by himself or herself. Namely, for example, in the system in which the text memo described above can be utilized, a user who tries to arrange the text memo on a virtual space has to create the text memo intentionally, and the work becomes complicated.

It is an object of at least one of embodiments according to the present invention to solve the problems described above, and to provide means capable of transferring information to third parties easily.

### Means for Solving the Problems

According to a non-limiting aspect, an image generating apparatus according to the present invention is an image generating apparatus including: a storage section configured to store an image and positional information, the image being to be transmitted to a terminal controlled by a first player, the positional information being information regarding a position within a virtual space in which an avatar operated by the first player exists; a receiving section configured to receive a control signal for a terminal of a second player; an updating section configured to update, on the basis of the control signal, a state of a video game in the virtual space in which the avatar operated by the first player, the state of the video game being stored in the storage section; an image generating section configured to generate, on the basis of the state of the video game updated by the updating section, an image to be transmitted to the terminal of the second player; and a transmitting section configured to transmit data to the terminal of the second player, the data corresponding to the image generated by the image generating section.

According to a non-limiting aspect, a program according to the present invention is a program for causing a computer to realize: a storing function configured to store an image to be transmitted to a terminal controlled by a first player and positional information within a virtual space in a predetermined storage region so that the image and the positional information are associated with each other, an avatar operated by the first player existing in the virtual space; a receiving function configured to receive a control signal for a terminal of a second player; an updating function configured to update, on the basis of the control signal, the state of the video game in the virtual space in which the avatar operated by the first player and stored in the predetermined storage region; an image generating function configured to generate, on the basis of the state of the video game updated by the updating function, an image to be transmitted to the terminal of the second player; and a transmitting function configured to transmit data to the terminal of the second player, the data corresponding to the image generated by the image generating function.

According to a non-limiting aspect, a terminal according to the present invention is a terminal that communicates with an image generating apparatus, wherein the image generating apparatus includes: a storage section configured to store an image and positional information, the image being to be transmitted to a terminal controlled by a first player, the positional information being information regarding a position within a virtual space in which an avatar operated by the first player exists; a receiving section configured to receive a control signal for a terminal of a second player; an updating section configured to update, on the basis of the control signal, a state of a video game in the virtual space in which the avatar operated by the first player, the state of the video game being stored in the storage section; an image generating section configured to generate, on the basis of a state of the video game updated by the updating section, an image to be transmitted to the terminal of the second player; and a transmitting section configured to transmit data to the terminal of the second player, the data corresponding to the image generated by the image generating section, and wherein the terminal includes means for operating as the terminal controlled by the first player or the terminal controlled by the second player.

According to a non-limiting aspect, an image generating system according to the present invention is an image generating system including a communication network, a server, a terminal controlled by a first player, and a terminal controlled by a second player, the image generating system including: a storage section configured to store an image to be transmitted to the terminal controlled by the first player and positional information within a virtual space in which an avatar operated by the first player exists; a receiving section configured to receive a control signal of the terminal of the second player; an updating section configured to update, on the basis of the control signal, a state of a video game in the virtual space in which the avatar operated by the first player and stored in the storage section exists; an image generating section configured to generate, on the basis of the state of the video game updated by the updating section, an image to be transmitted to the terminal of the second player; and a transmitting section configured to transmit data to the terminal of the second player, the data corresponding to the image generated by the image generating section.

### Effects of the Invention

According to each of the embodiments of the present application, one or two or more shortages are solved.

### BRIEF DESCRIPTION OF THE DRAWINGS

FIG. 1 is a block diagram showing an example of a configuration of a video game processing system corresponding to at least one of embodiments according to the present invention.

FIG. 2 is a block diagram showing a configuration of an example of a video game processing server corresponding to at least one of the embodiments according to the present invention.

FIG. 3 is a flowchart showing an example of game processing corresponding to at least one of the embodiments according to the present invention.

FIG. 4 is a block diagram showing a configuration of an example of the video game processing server corresponding to at least one of the embodiments according to the present invention.

FIG. 5 is an explanatory drawing for explaining an example of information stored in a storage section, which corresponds to at least one of the embodiments according to the present invention.

FIG. 6 is a flowchart showing an example of the game processing corresponding to at least one of the embodiments according to the present invention.

FIG. 7 is an explanatory drawing for explaining an example of a synthesized image corresponding to at least one of the embodiments according to the present invention.

FIG. 8 is an explanatory drawing for explaining an attitude of a first image corresponding to at least one of the embodiments according to the present invention.

FIG. 9 is an explanatory drawing for explaining the attitude of the first image corresponding to at least one of the embodiments according to the present invention.

FIG. 10 is a block diagram showing a configuration of an example of the video game processing server corresponding to at least one of the embodiments according to the present invention.

FIG. 11 is a flowchart showing an example of the game processing corresponding to at least one of the embodiments according to the present invention.

FIG. 12 is an explanatory drawing for explaining an example of an image corresponding to at least one of the embodiments according to the present invention.

FIG. 13 is a block diagram showing a configuration of an example of the video game processing server corresponding to at least one of the embodiments according to the present invention.

FIG. 14 is a flowchart showing an example of the game processing corresponding to at least one of the embodiments according to the present invention.

FIG. 15 is a block diagram showing a configuration of an example of the video game processing server corresponding to at least one of the embodiments according to the present invention.

FIG. 16 is a flowchart showing an example of the game processing corresponding to at least one of the embodiments according to the present invention.

FIG. 17 is a block diagram showing an example of the video game processing server corresponding to at least one of the embodiments according to the present invention.

FIG. 18 is a flowchart showing an example of the game processing corresponding to at least one of the embodiments according to the present invention.

### DESCRIPTION OF EMBODIMENT

Hereinafter, examples of embodiments according to the present invention will be described with reference to the drawings. In this regard, various kinds of elements in an example of each embodiment, which will be described below, can appropriately be combined with each other in a range where contradiction or the like does not occur. Further, explanation of the content that will be described as an example of an embodiment may be omitted in another embodiment. Further, the content of operations and/or processing with no relationship to characteristic portions of each embodiment may be omitted. Moreover, various kinds of processing that constitute various kinds of processing flows (will be described below) may be carried out in random order in a range where contradiction or the like does not occur in the content of the processing.

Further, a type of system used by an image generating apparatus according to the present invention is not particularly limited. Hereinafter, a case where the image generating apparatus is used as a video game processing server in a video game processing system for controlling progress of a video game will be described as an example.

### First Embodiment

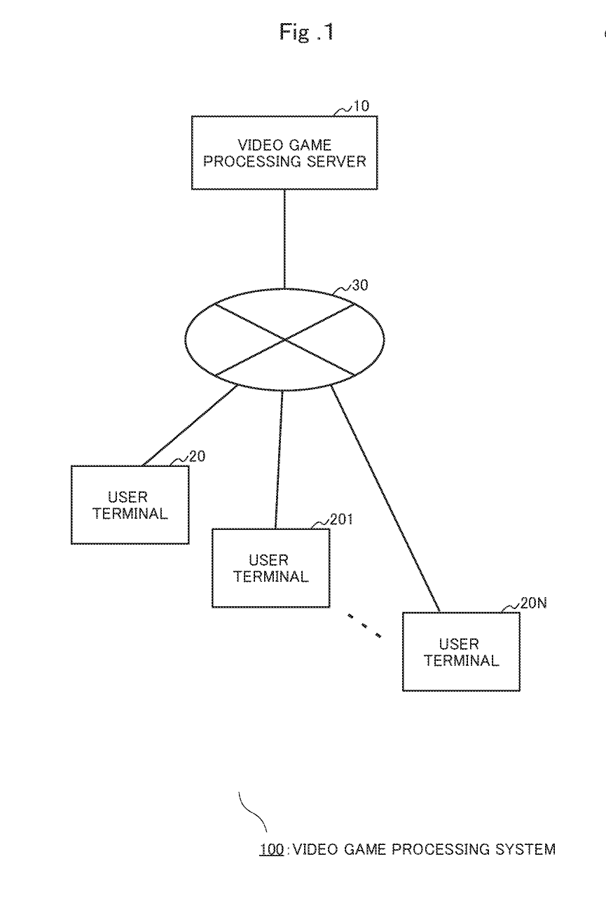

FIG. 1 is a block diagram showing an example of a configuration of a video game processing system 100 according to one embodiment of the present invention. As shown in FIG. 1, the video game processing system 100 includes a video game processing server 10, and user terminals 20 and 201 to 20N (“N” is an arbitrary integer) respectively used by a plurality of users. In this regard, the configuration of the video game processing system 100 is not limited to this. The video game processing system 100 may be configured so that a plurality of users uses a single user terminal, or may be configured so as to include a plurality of servers.

Each of the video game processing server 10 and the plurality of user terminals 20 and 201 to 20N is connected to a communication network 30 such as the Internet. In this regard, although it is not shown in the drawings, the plurality of user terminals 20 and 201 to 20N is connected to the communication network 30 by carrying out data communication with base stations managed by a telecommunication carrier by means of a radio communication line.

The video game processing system 100 has various kinds of functions to control progress of a video game (so-called online game) that a plurality of players plays in the same virtual space (including a synchronized virtual space and a non-synchronized virtual space).

The video game processing server 10 is managed by an administrator of the video game processing system 100, and has various kinds of functions to provide information regarding to the video game to each of the user terminals 20 and 201 to 20N.

The video game processing server 10 is configured by an information processing apparatus, such as a WWW server, and includes a storage medium for storing various kinds of information. In this regard, in the video game processing system 100, it is preferable that information regarding the video game is managed by the video game processing server 10 in view of reduction of a processing load on each of the plurality of user terminals 20 and 201 to 20N.

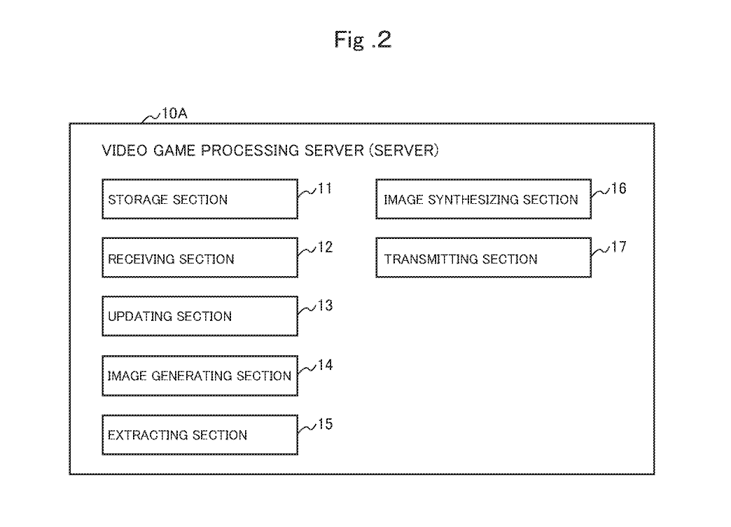

FIG. 2 is a block diagram showing a configuration of an example of a video game processing server 10A (hereinafter, referred to as the “the server 10A”) that is an example of the video game processing server 10 according to one of the embodiments of the present invention. The server 10A includes at least a storage section 11, a receiving section 12, an updating section 13, an image generating section 14, an extracting section 15, an image synthesizing section 16, and a transmitting section 17. In this regard, the server 10A is provided with a general configuration for carrying out image generation, such as a control section. However, its explanation will be omitted herein.

The storage section 11 has a function to store an image to be transmitted to the terminal controlled (or operated; the same applies to the following) by the first player and positional information (positional information) in the virtual space in which the avatar operated by the first player exists so at to be associated with each other.

Here, the first player (first player) is a user who plays the video game by operating any of the plurality of user terminals 20 and 201 to 20N.

Further, the image to be transmitted to the terminal controlled by the first player is an image to be displayed on a display screen of the user terminal operated by the first player. Namely, the image to be transmitted is an image constituting a game screen.

Further, the avatar means one that can become a target operated by a player. The avatar according to the present embodiment is not necessarily a character displayed on the display screen as an avatar (or his or her self) of the first player. Namely, as the avatar according to the present embodiment, one that can be operated by the player and whose position can be defined in the virtual space, such as a so-called player character or a virtual viewpoint, can be adopted alternatively.

Further, the positional information is identification information indicating coordinates in the virtual space or a predetermined region in the virtual space.

The receiving section 12 has a function to receive a control signal for a terminal of a second player.

Here, the second player (second player) means a user who plays the video game by operating any of the plurality of user terminals 20 and 201 to 20N, and who is allowed to display an image to be transmitted to other user (in the present embodiment, the first player) on the display screen of the user terminal operated by oneself. In this regard, there is a possibility that a user became the first player at a certain point of time, but the user becomes the second player at another point of time.

The updating section 13 has a function to update the state of the video game on the basis of the control signal.

The image generating section 14 has a function to generate an image to be transmitted to the terminal of the second player on the basis of a state of the video game updated by the updating section 13.

The extracting section 15 has a function to extract an image regarding a position of the avatar operated by the second player in the virtual space from the storage section on the basis of the positional information.

The image synthesizing section 16 has a function to synthesize the image generated by the image generating section 14 and the image extracted by the extracting section 15 to generate an image (synthesized image).

The transmitting section 17 has a function to transmit the synthesized image to the terminal of the second player. More specifically, the transmitting section 17 has a function to transmit data corresponding to the synthesized image to the terminal of the second player. Hereinafter, the same also applies to various kinds of images to be received and transmitted.

Next, an operation of the video game processing system 100 according to the present embodiment (hereinafter, referred to as the “system 100”) will be described.

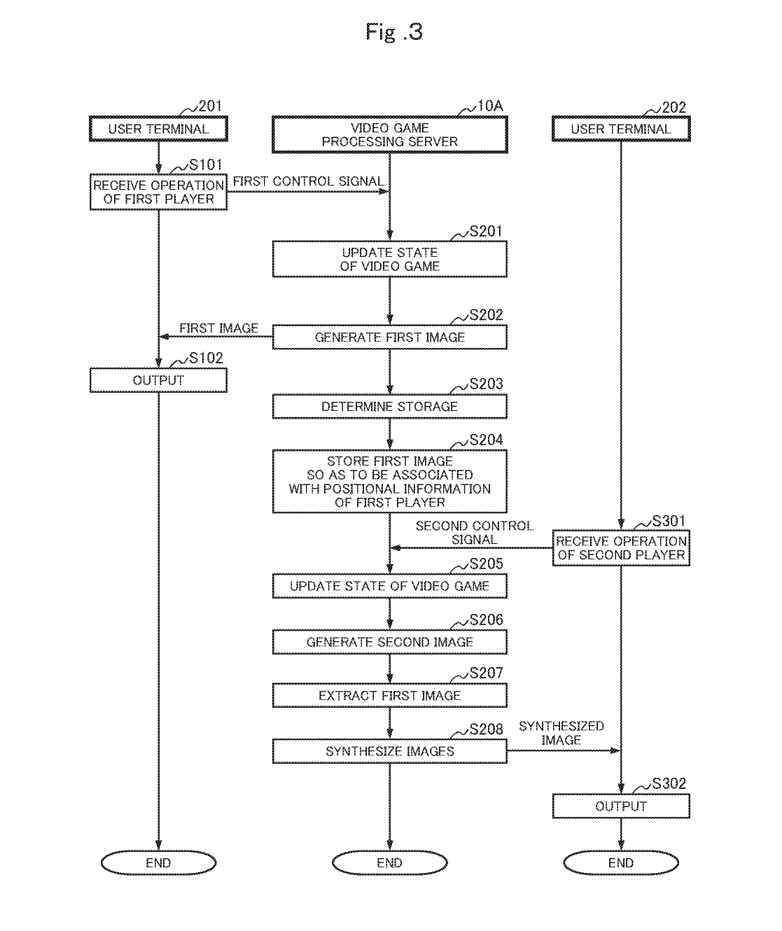

FIG. 3 is a flowchart showing an example of game processing carried out by the system 100. In the game processing according to the present embodiment, processing to synthesize at least a part of an image to be transmitted to the first player and an image transmitted to the second player and output the synthesized image to a user terminal operated by the second player is carried out. Hereinafter, a case where the terminal of the first player is a user terminal 201 (hereinafter, referred to as the “terminal 201”) and the terminal of the second player is a user terminal 202 (hereinafter, referred to as the “terminal 202”) will be described as an example.

The game processing is started in a case where the terminal 201 receives a request to start the video game from the first player, for example.

In the game processing, the terminal 201 first receives an operation of the first player, and transmits a control signal (first control signal) according to the received operation to the server 10A (Step S101). In the present embodiment, the terminal 201 transmits, to the server 10A, the content of the operation by the first player and the first control signal that includes the identification information capable of uniquely specifying the first player.

When the first control signal is received, the server 10A updates the state of the video game on the basis of the received first control signal (Step S201). In the present embodiment, the server 10A carries out processing for reflecting an operation of the first player to a state of the virtual space corresponding to the first player. As an example of the processing, update of the positional information according to an operation of the first player is included, for example.

When the state of the video game is updated, the server 10A generates a first image (Step S202). In the present embodiment, the server 10A generates an image, which indicates a virtual space in which the avatar operated by the first player is positioned, as the first image, and transmits the generated first image to the terminal 201.

When the first image is received, the terminal 201 outputs the received first image (Step S102), and terminates the processing herein.

When the first image is generated, the server 10A carries out determination of whether the generated first image is to be stored or not (storage determination) (Step S203). In the present embodiment, the server 10A determines whether specific information is associated with identification information of the first player or not. Here, the content of the specific information is not particularly limited. In the present embodiment, the specific information indicates other character (monster). Namely, in the present embodiment, the server 10A determines that the first image is to be stored in a case where the avatar of the first player takes the monster along.

When the storage determination is carried out, the server 10A stores the generated first image so as to be associated with the positional information of the first player (Step S204). In the present embodiment, the server 10A stores the first image, the positional information and the identification information of the first player in a predetermined storage region so as to be associated with each other.

On the other hand, the terminal 202 operated by the second player different from the first player receives an operation of the second player (Step S301). In the present embodiment, the terminal 202 transmits a second control signal, which contains the content of the operation by the second player and identification information capable of uniquely specifying the second player, to the server 10A. In this regard, in the present embodiment, the avatars respectively operated by the first player and the second player may be positioned in an associatable virtual space on the basis of the positional information, and the virtual space in which the avatar operated by the first player is positioned may be the same as or different from the virtual space in which the avatar operated by the second player is positioned.

When the second control signal is received, the server 10A updates the state of the video game on the basis of the received second control signal (Step S205). In the present embodiment, the server 10A carries out processing for reflecting an operation of the second player to a state of the virtual space corresponding to the second player.

When the state of the video game is updated, the server 10A generates a second image (Step S206). In the present embodiment, the server 10A generates an image indicating a virtual space in which the avatar operated by the first player is positioned as the second image.

When the second image is generated, the server 10A extracts the first image (Step S206). In the present embodiment, the server 10A extracts the first image in which the position of the avatar operated by the second player in the virtual space is associated with the positional information of the virtual space associated in advance.

When the first image is extracted, the server 10A synthesizes the generated second image and the extracted first image (Step S208). In the present embodiment, the server 10A carries out image synthetization so that the first image is arrange on a part of the second image. Further, in the present embodiment, the synthesized image is transmitted to the terminal 202 by the server 10A.

When the synthesized image is received, the terminal 202 outputs the received synthesized image (Step S302), and terminates the processing herein.

As explained above, as one side of the first embodiment, the image generating apparatus (for example, the server 10A) is configured so as to: include the storage section 11, the receiving section 12, the updating section 13, the image generating section 14, the extracting section 15, the image synthesizing section 16, and the transmitting section 17; store an image and positional information, the image being to be transmitted to the terminal (for example, the terminal 201) controlled by the first player, the positional information being information regarding a position in the virtual space in which an avatar operated by the first player exists (for example, Step S204); receive a control signal for the terminal (for example, the terminal 202) of the second player (for example, Step S205); update the state of the video game on the basis of the control signal (for example, Step S205); generate the image to be transmitted to the terminal of the second player on the basis of the updated state of the video game (for example, Step S206); extract the image related to the position of the avatar operated by the second player in the virtual space on the basis of the positional information (for example, positional information stored so as to be associated with the first image) (for example, Step S207); synthesize the generated image and the extracted image to generate a synthesized image (for example, Step S208); and transmit the data corresponding to the synthesized image to the terminal of the second player (for example, Step S208). Therefore, it is possible to transfer information to third parties easily.

Namely, by configuring the image generating apparatus so as to extract the image regarding the avatar operated by the first player on the basis of the position of the avatar operated by other player to provide the image to the other player, it becomes possible to intentionally remove necessity of the first player for carrying out a work to create an image. For this reason, the other player is allowed to browse the image regarding the avatar operated by the first player independently of an intention of the first player.

In this regard, it has not been particularly mentioned in the example of the first embodiment described above. However, the image generating apparatus (for example, the server 10A) may be configured so as to store the image (for example, the first image) to be transmitted to the terminal (for example, the terminal 201) controlled by the first player substantially at the same time as timing when the control signal (for example, the second control signal) for the terminal of the second player is received. By configuring the image generating apparatus in this manner, it is possible to transfer the information regarding the first player to the second player in real time.

Further, in the example of the first embodiment described above, the image generating apparatus (for example, the server 10A) is configured so as to store the image to be transmitted to the terminal controlled by the first player before a control signal (for example, the second control signal) for the terminal of the second player is received (for example, Step S204). Therefore, it becomes possible to provide means for transferring information to third parties in archive format.

In this regard, it has not been particularly mentioned in the example of the first embodiment described above. However, the image generating apparatus may be configured so that the image to be transmitted to the terminal controlled by the first player, which has been stored once, is deleted from the storage region of the image generating apparatus (for example, the server 10A). Alternatively, the image generating apparatus may be configured so that the image has been stored for a certain period of time or until a predetermined condition is satisfied.

In this regard, it has not been particularly mentioned in the example of the first embodiment described above. However, the image generating apparatus (for example, the server 10A) may be configured so as to select the predetermined number of images in accordance with a predetermined priority rule in a case where it is determined that there are plural images related to the position of the avatar operated by the second player in the virtual space.

Further, in the example of the first embodiment described above, the image generating apparatus (for example, the server 10A) is configured so as to store the image to be transmitted to the terminal controlled by the first player in a case where specific information is associated with identification information of the first player (for example, Step S204). Therefore, it is possible to adjust an amount of videos to be generated or stored effectively.

In this regard, a standard of the storage determination is not limited to the content of the embodiment described above. The image generating apparatus may be configured so as to be capable of storing images that are thought to become effective for a third party. As an example of the standard of the storage determination, the image generating apparatus (for example, the server 10A) can also be configured so as to store an image to be transmitted to the terminal controlled by the first player when the state of the video game corresponding to the first player becomes a predetermined status. Here, a status that it is in a so-called boss battle, a status that the avatar died, and the like are thought as examples of the predetermined status.

Further, in the example of the first embodiment described above, the image generating apparatus is configured so that the positional information is identification information indicating coordinates in the virtual space or a predetermined region in the virtual space. Therefore, it becomes possible to extract the image related to the position of the avatar operated by the second player in the virtual space easily.

In this regard, it has not been particularly mentioned in the example of the first embodiment described above. However, the image treated by the image generating apparatus (for example, the server 10A) may be a still image, or may be a video (animated film). Further, the image generating apparatus may be configured so that a still image is synthesized with a video, or so that a video is synthesized with a still image. For a still image and a video, necessary processing related to a reproduction time and/or an information volume may be different from each other, for example. However, its explanation will be omitted herein.

In this regard, it has not been particularly mentioned in the example of the first embodiment described above. However, the image generating apparatus (for example, the server 10A) may be configured so as to specify the first player corresponding to the identification information of the second player; and extract the specified the image to be transmitted to the terminal controlled by the first player. As an example of the first player corresponding to the identification information of the second player, a so-called friend-registered first player is thought.

In this regard, the case where the server 10A includes the various kinds of functions has been described in the example of the first embodiment described above. However, the server 10A may be configured so that a part or all of the various kinds of functions included by the server 10A is not included in the video game processing server as the image generating apparatus, but is included in the user terminal (for example, terminal 20).

### Second Embodiment

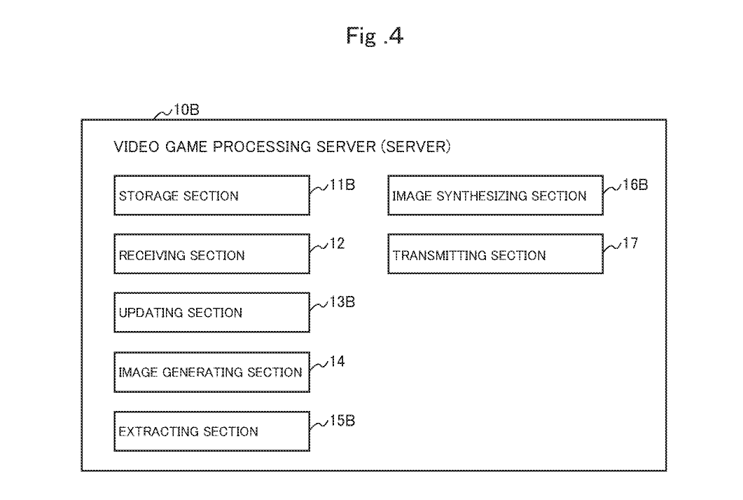

FIG. 4 is a block diagram showing a configuration of the video game processing server 10B (hereinafter, referred to as the “server 10B”) that is an example of the video game processing server 10 according to one of the embodiments according to the present invention. The server 10B includes at least a storage section 11B, a receiving section 12, an updating section 13, an image generating section 14, an extracting section 15B, an image synthesizing section 16B, and a transmitting section 17. In this regard, the server 10B includes a general configuration for carrying out image generation such as a control section. However, its explanation will be omitted herein.

The storage section 11B has a function to store an image to be transmitted to the terminal controlled by the first player.

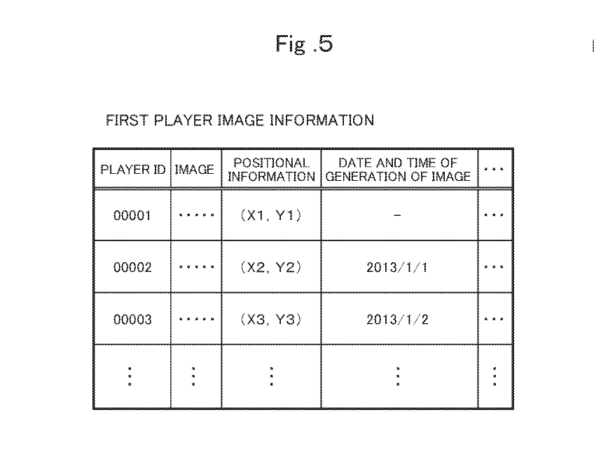

FIG. 5 is an explanatory drawing for explaining an example of information stored in the storage section 11B. Here, an example of a storage state of information regarding an image to be transmitted to the terminal controlled by the first player (first player image information) in a predetermined storage region will be described.

As shown in FIG. 5, the first player image information according to the present embodiment contains at least a player ID, an image, positional information, and date and time of generation of the image.

Here, for example, the image may be image data for displaying an arbitrary image on a display screen of a display device included in the user terminal 201, or the image may be an address for accessing the image data stored in the server 10B.

The extracting section 15B has a function to extract an image to be transmitted to the terminal controlled by the first player from the storage section 11B.

The image synthesizing section 16B has a function to insert an image constituting the image extracted by the extracting section 15B into a region of at least a part of at least one image constituting the image generated by the image generating section 14 to generate a synthesized image.

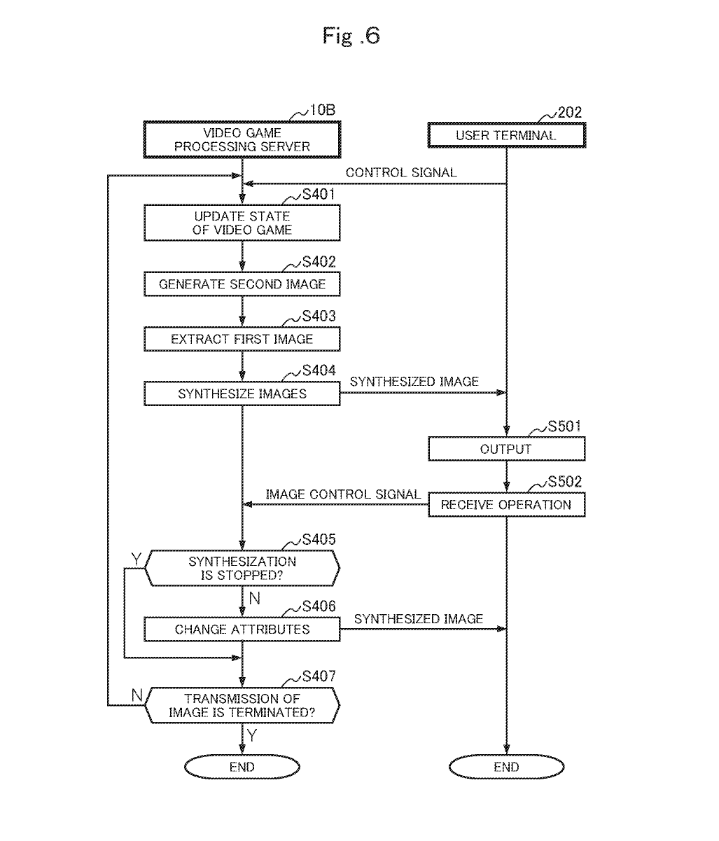

FIG. 6 is a flowchart showing an example of the game processing carried out by the system 100. In the game processing according to the present embodiment, processing in which the server 10B causes the user terminal operated by the second player to output an image according to the received control signal to the user terminal is carried out. Hereinafter, a case where the terminal of the second player is the user terminal 202 (the terminal 202) will be described as an example.

The game processing is started when the terminal 202 transmits a control signal according to an operation of the second player to the server 10B, for example.

When the control signal is received from the terminal 202, the server 10B updates the state of the video game on the basis of the received control signal (Step S401).

When the state of the video game is updated, the server 10B generates a second image according to the state of the video game (Step S402).

When the second image is generated, the server 10B extracts the first image (Step S403). In the present embodiment, the server 10B specifies positional information of the avatar operated by the second player from video game information stored in a predetermined storage region on the basis of the identification information of the second player contained in the received control signal. The server 10B then refers to the first player image information (see FIG. 5), and extracts, as the first image, the image with which the positional information related to the specified positional information is associated.

When the first image is extracted, the server 10B synthesizes the generated second image and the extracted first image (Step S404). In the present embodiment, the server 10B superimposes an image constituting the image extracted by the extracting section 15B on at least a part of a region of the at least one image constituting the image generated by the image generating section 14.

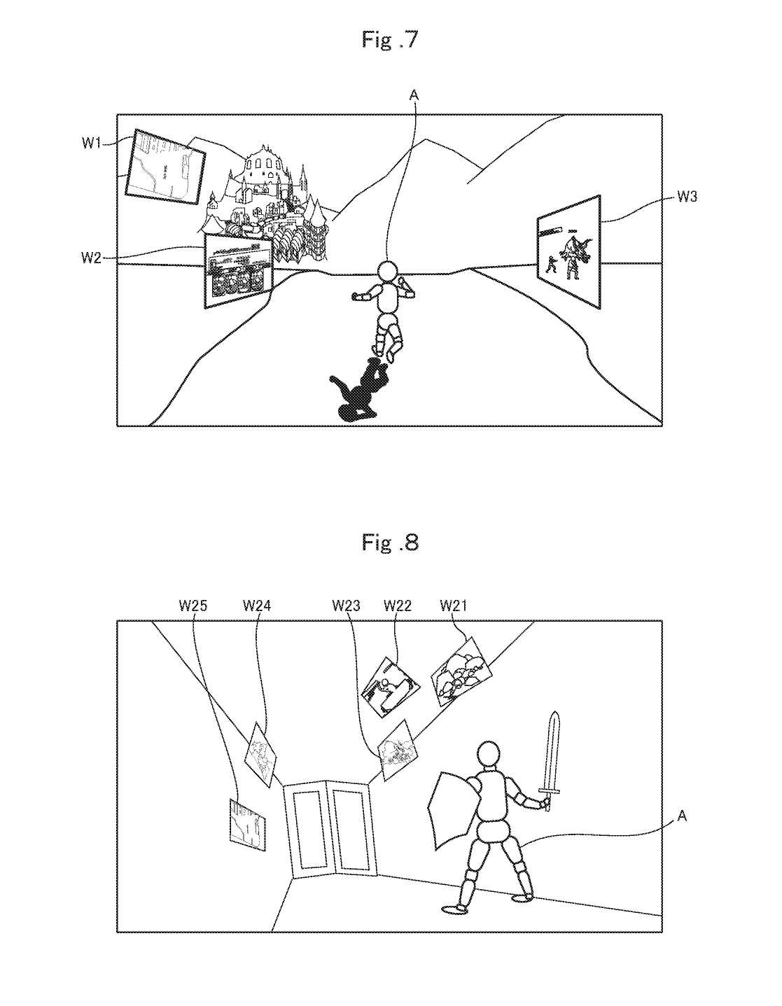

FIG. 7 is an explanatory drawing for explaining an example of the synthesized image. As shown in FIG. 7, the synthesized image is an image in which a plurality of windows W1, W2, W3 indicating the image to be transmitted to the terminal controlled by the first player (still image or video) is arranged on an image indicating a virtual space in which an avatar A operated by the second player exists (for example, an image of a road on which the avatar A moves or a background image).

When the synthesized image is received from the server 10B, the terminal 202 outputs the received synthesized image (Step S501). Then, the terminal 202 receives an operation of the second player (Step S502). In the present embodiment, the terminal 202 transmits an image control signal according to the received operation to the server 10B whenever an operation of the second player is received.

When the image control signal is received by the terminal 202, the server 10B carries out determination (synthetization stop determination) of whether the synthetization of the images is stopped or not on the basis of the received image control signal (Step S405).

Here, in a case where it is determined that the synthetization of the images is not stopped (“No” at Step S405), the server 10B changes an attitude of the first image (Step S406).

Here, the attitude is a position of the region into which the first image is inserted on a display size of the first image or the second image. In this regard, in the present embodiment, the server 10B inserts the extracted first image into the generated second image on the basis of a predetermined standard when the server 10B first synthesizes the images. An attitude set up by the user (display size and insert position) is thought as an example of the predetermined standard.

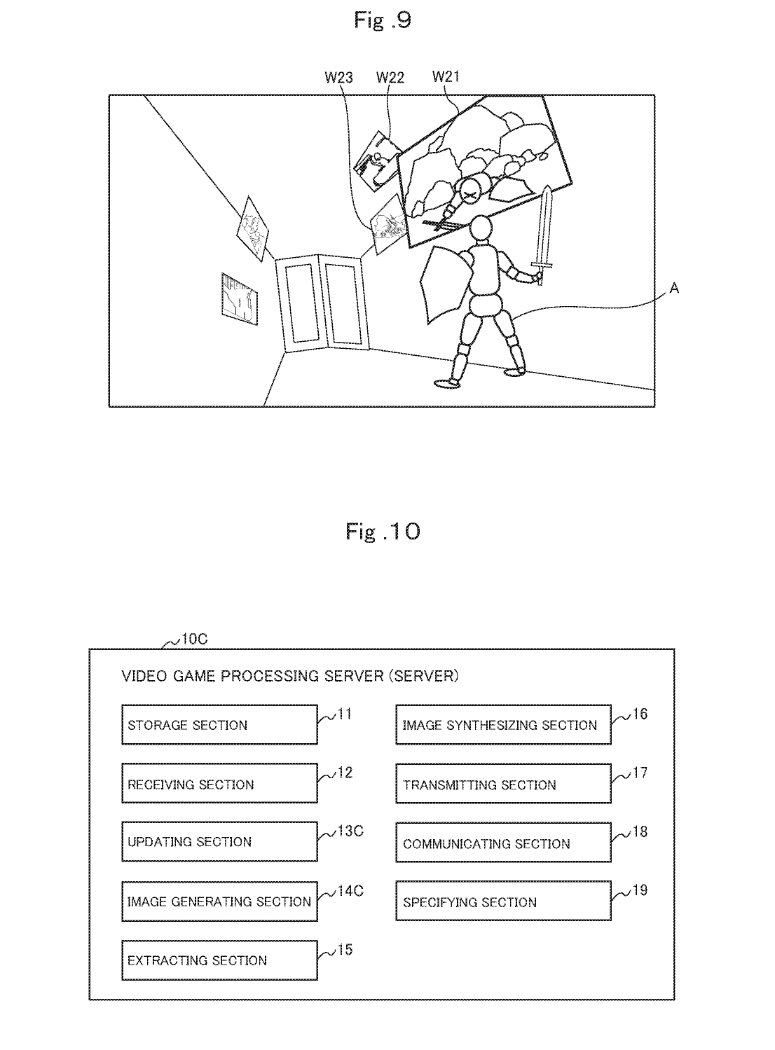

FIG. 8 and FIG. 9 are explanatory drawings for explaining the attitude of the first image. As shown in FIG. 8, a plurality of first images W21, W22, W23, W24, W25 is inserted into an image of a virtual space in which the avatar A of the second player is positioned. At this time, for example, when an image control signal for indicating that the second player selects the first image W21 is received, the server 10B generates a synthesized image obtained by changing the attitude (in the present embodiment, the display size) of the first image W21 as shown in FIG. 9.

On the other hand, in a case where it is determined that the synthesis of the images is stopped (“Yes” at Step S405), the server 10B determines whether transmission of the image is to be terminated or not (Step S407). Here, in a case where it is determined that the transmission of the image is to be terminated (“Yes” at Step S407), the server 10B terminates the processing herein.

As explained above, as one side of the second embodiment, the image generating apparatus (for example, the server 10A) is configured so as to: include the storage section 11B, the receiving section 12, the updating section 13, the image generating section 14, the extracting section 15B, the image synthesizing section 16B and the transmitting section 17; store the image to be transmitted to the terminal controlled by the first player (for example, store the first player image information); receive the control signal for the terminal (for example, the terminal 202) of the second player (for example, Step S401); update the state of the video game on the basis of the control signal (for example, Step S401); generate the image to be transmitted to the terminal of the second player on the basis of the updated state of the video game (for example, Step S402); extract the image to be transmitted to the terminal controlled by the first player (for example, the first image) from the storage section 11B (for example, Step S403); insert the image constituting the extracted image into the region of at least the part of at least one image constituting the generated image to generate the synthesized image (for example, Step S404); and transmit the data corresponding to the synthesized image to the terminal of the second player (for example, Step S404). Therefore, the other player is allowed to browse the video regarding the avatar operated by the first player independently of an intention of the first player.

Further, in the example of the second embodiment described above, the image generating apparatus (for example, the server 10B) is configured so as to: receive the image control signal from the terminal of the second player (for example, Step S405); and change the attitude of image to be inserted on the basis of the received image control signal (for example, Step S406). Therefore, it becomes possible to provide information with high convenience for the user.

Further, in the example of the second embodiment described above, the image generating apparatus is configured so that the attitude is a display size of an image to be inserted or a position of the part of the region on the one image. Therefore, processing to set up a display form of an image becomes easy first.

Further, in the example of the second embodiment described above, the image generating apparatus (for example, the server 10B) is configured so as to: receive the image control signal from the terminal of the second player; and stop insertion of the image on the basis of the image control signal (for example, “Yes” at Step S405). Therefore, it is possible to avoid an unnecessary first image from being inserted into the second image.

Further, in the example of the second embodiment described above, the image generating apparatus (for example, the server 10B) is configured so as to superimpose the image constituting the extracted image on at least a part of the region of at least one image constituting the generated image (for example, Step S404). Therefore, it is possible to generate a synthesized image with high visibility.

In this regard, it has not been particularly mentioned in the example of the second embodiment described above. However, the image generating apparatus (for example, the server 10B) displays the first image whose attitude is changed in preference to other first image. Namely, for example, as shown in FIG. 9, the first image W21 whose attitude was changed is displayed so that a part of the first image W21 is superimposed on the first images W22, W23 whose attitudes are not changed.

In this regard, it has not been particularly mentioned in the example of the second embodiment described above. However, it is preferable that the terminal (for example, the terminal 202) of the second player is a so-called touch device. By allowing the second player to obtain a feeling to directly touch the first image or carry out an operation (more specifically, a pinch operation, a drag operation, a flick operation and the like) for magnification or reduction of the first image, moving an unnecessary first image out of his or her way, or moving the display position of the first image, it is possible to enhance usefulness of the synthesized image.

### Third Embodiment

FIG. 10 is a block diagram showing a configuration of a video game processing the server 10C (hereinafter, referred to as the “server 10C”), which is an example of the video game processing server 10 according to one of the embodiments of the present invention. The server 100 includes at least a storage section 11, a receiving section 12, an updating section 13C, an image generating section 14C, an extracting section 15, an image synthesizing section 16, a transmitting section 17, a communicating section 18, and a specifying section 19.

The updating section 13C has a function to update a state of a video game so that a position of an avatar operated by a second player becomes a position (related position) related to a position (reference position) within a virtual space in which an avatar operated by a first player exists in a case where a control signal contains a signal indicating an operation of a second player with respect to an image (extracted image) extracted by the extracting section 15.

Here, the control signal means a control signal that the server 10C receives from the terminal operated by the second player. Further, the signal indicating the operation of the second player with respect to the extracted image (extracted image operation signal) means an operation signal associated with the extracted image, and its configuration is not particularly limited. In the present embodiment, a case where the image operation signal indicates a touch operation with respect to a display region of the image extracted by the extracting section and displayed in the terminal of the second player will be described as an example.

Further, the related position means a derivable position on the basis of the reference position. Although a condition of the related position is not particularly limited, it is preferable that the related position is in the same virtual space as that for the reference position. Examples of the related position include “a position within a predetermined distance (for example, within a range of several meter radius) from a reference position” in a video game with concept of a distance and “a position at which the reference position enters the field of view” in a video game with a concept of a field of view corresponding to the second player or the avatar operated by the second player.

The communicating section 18 has a function to communicate with each of a plurality of servers respectively corresponding to a plurality of areas constituting the video game. In the present embodiment, the communicating section 18 communicates with a group of servers (not shown in the drawings), which are associated with a predetermined area in advance, via the communication network 30.

Here, the server corresponding to the area means a server in which various kinds of information for controlling the video game in the area are stored. In this regard, a known technique is used for a technique to control progress of the video game in which the plurality of users participates using the plurality of servers (for example, a technique to manage a plurality of areas using a plurality of servers). Thus, its detailed explanation will be omitted.

The specifying section 19 has a function to specify an area corresponding to the state of the video game updated by the updating section 13C.

Here, the method of specifying an area is not particularly limited. Examples of a method of specifying an area include a method of searching identification information of the area selected by a player from a predetermined storage region. Further, in the present embodiment, the communicating section 18 has a function to communicate with a server corresponding to the area specified by the specifying section 19.

The image generating section 14C has a function to generate an image to be transmitted to the terminal of the second player using data contained in a communication result by the communicating section 18.

Here, the data contained in the communication result (communication data) may be data by which an image can be transmitted to a terminal as a result, and its configuration is not particularly limited. Examples of the communication data include data indicating an image generated by a server other than the server 10C and data for generating an image in the server 100.

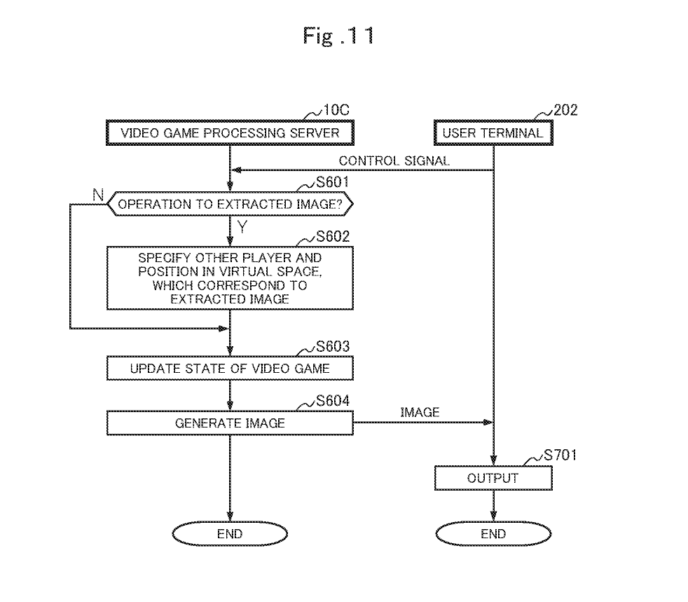

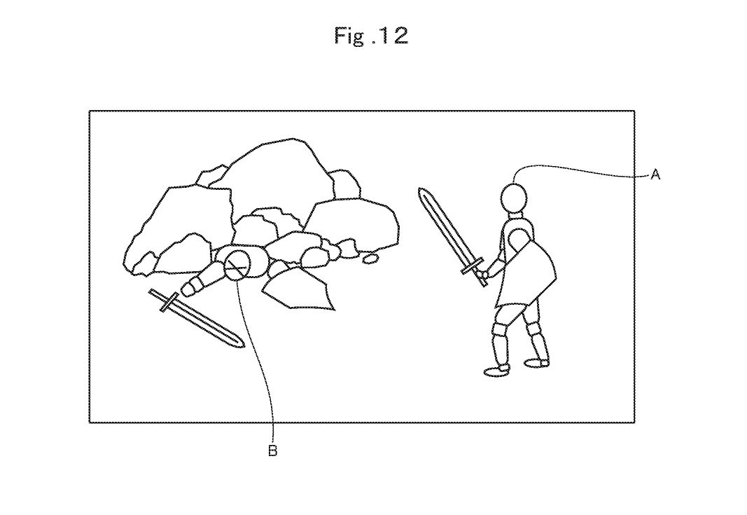

FIG. 11 is a flowchart showing an example of the game processing carried out by the system 100. In the game processing according to the present embodiment, processing in which the server 100 outputs an image according to a control signal received by a user terminal operated by the second player to the user terminal is carried out. Hereinafter, a case where the terminal of the second player is the user the terminal 202 (the terminal 202) will be described as an example.

The game processing is started when the terminal 202 transmits a control signal according to an operation of the second player to the server 100, for example.

In the game processing, when a control signal is received from the terminal 202, the server 100 first determines whether the received control signal contains an operation to an extracted image or not (Step S601). Here, in a case where it is determined that the control signal does not contain an operation to the extracted image (“No” at Step S601), the server 100 causes a processing flow to shift to a process at Step S603 (will be described later).

On the other hand, in a case where it is determined that the control signal contains an operation to the extracted image (“Yes” at Step S601), the server 10C specifies other player corresponding to the extracted image and the position corresponding to the extracted image in the virtual space (Step S602).

Here, the other player corresponding to the extracted image means a player that can be identified by means of the player ID stored in the storage section 11 so as to be associated with the extracted image. Namely, in the present embodiment, the other player corresponding to the extracted image means the first player corresponding to the extracted image selected by the second player. Further, the position corresponding to the extracted image in the virtual space means a position that can be specified by means of the positional information stored so as to be associated with the extracted image.

When the other player and the position corresponding to the extracted image is specified, the server 10C updates the state of the video game on the basis of the received control signal (Step S603). Here, in a case where the control signal contains a signal indicating an operation against the extracted image (“Yes” at Step S601), the server 10C updates the state of the video game on the basis of the specified other player and position. In the present embodiment, the server 10C updates the state of the video game so that the position of the second player in the virtual space becomes a position at which a predetermined condition for the specified other player is satisfied. In this regard, examples of the update mode for the state of the video game include a mode to move (or warp) the position in the virtual space in which the avatar operated by the second player exists to the vicinity of other player.

When the state of the video game is updated, the server 100 generates an image on the basis of the updated state of the video game (i.e., a result from update of the state of the video game; or an update result of the state of the video game) (Step S604), and terminates the processing herein. In the present embodiment, the server 100 specifies an area corresponding to the updated state of the video game; communicates with a server corresponding to the specified area; generates an image to be transmitted to the terminal of the second player using data contained in a communication result; and transmits the generated image to the terminal 202.

When the image transmitted by the server 10C is received, the terminal 202 outputs the received image (Step S701), and terminates the processing herein.

FIG. 12 is an explanatory drawing for explaining an example of the image generated in the game processing according to the present embodiment. In a case where the video game screen corresponding to FIG. 9 described above is displayed in the terminal 202, the player selects the first image W21. In this case, at Step S604 in the game processing according to the present embodiment, an image (information) for displaying the video game screen corresponding to FIG. 12 on a display screen of a display device included in the terminal 202 is generated. Thus, in a case where the second player selects the first image W21, it is possible to realize a representation (warp representation) so that “the avatar A of the second player moves into the first image W21”.

As explained above, as one side of the third embodiment, the image generating apparatus (for example, the server 100) is configured so as to: include the storage section 11, the receiving section 12, the updating section 13C, the image generating section 14C, the extracting section 15, the image synthesizing section 16, the transmitting section 17, the communicating section 18 and the specifying section 19; and update the state of the video game so that the position of the avatar operated by the second player becomes the position related to the position related to the position in the virtual space in which the avatar operated by the first player exists (for example, Step S602) in a case where the control signal contains the signal indicating the operation of the second player with respect to the image extracted by the extracting section (for example, “Yes” at Step S601). Therefore, it is possible to cause the second player (or a target operated by the second player; for example, avatar) to move to the virtual space corresponding to the selected image in response to an image selecting operation by the second player.

Namely, it is possible to provide information to a player as a third party in the form so as to serve as means for moving to other player.

Further, in the example of the third embodiment described above, the image generating apparatus is configured so that the operation of the second player includes the touch operation with respect to a display region of the image extracted by the extracting section and displayed in the terminal of the second player. Therefore, it is possible to realize the movement by means of an intuitive operation.

Further, in the example of the third embodiment described above, the image generating apparatus (for example, the server 10C) is configured so as to: communicate with each of the plurality of servers respectively corresponding to the plurality of areas constituting the video game; specify the area corresponding to the updated state of the video game; communicate with the server corresponding to the specified area; and generate the image to be transmitted to the terminal of the second player using the data contained in the communication result. Therefore, it is possible to realize a system capable of moving between the plurality of areas for which the corresponding servers are different from each other.

Further, the image generating apparatus may be configured: so as to include the plurality of servers each of which is in a state where information of the corresponding area is read; and so that the image generating apparatus (for example, the server 100) serves as a cloud gaming server. In this case, it is preferable to configure the image generating apparatus so that, when the player (or the avatar operated by the player) moves from a first server to a second server, an image is generated in the second server side. Namely, it is preferable that, in a case where a warp destination associated with image selection is an area different from an area before movement, for example, the image generating apparatus is configured so as to generate an image by selectively choosing a server on which a resource is loaded, thereby improving speed of the image generation.

### Fourth Embodiment

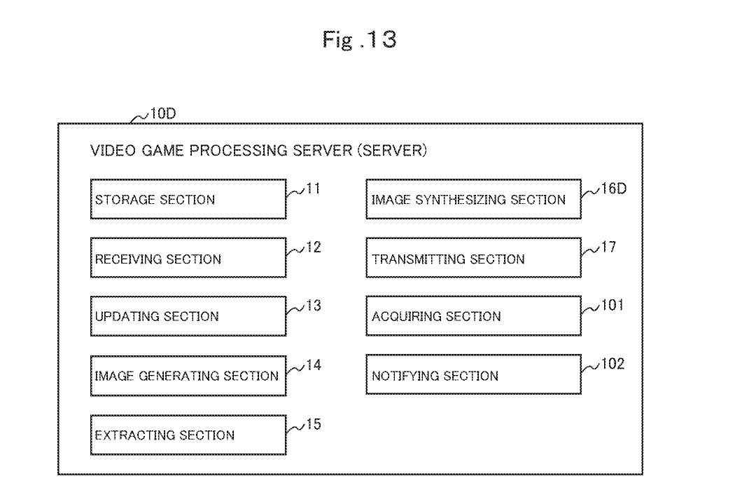

FIG. 13 is a block diagram showing a configuration of an example of a video game processing server 10D (hereinafter, referred to as the “server 10D”) that is an example of the video game processing server 10 corresponding to one of the embodiments according to the present invention. The server 10D includes at least a storage section 11, a receiving section 12, an updating section 13, an image generating section 14, an extracting section 15, an image synthesizing section 16D, a transmitting section 17, an acquiring section 101, and a notifying section 102.

The acquiring section 101 has a function to acquire an image regarding a video game from a server (a progress control server; not shown in the drawings) configured so as to control progress of the video game that is associated with a first player and a second player. The image is associated with the second player.

Here, the progress control server means a server for controlling progress of portions of the video game different from those controlled by the server 10D. Conditions and the like of the portions of the video game which the progress control server is in charge are not particularly limited. However, it is preferable to be a part of the video game in which the plurality of players can participate. Examples of the progress control server include a server (raid boss server) configured to control progress of a battle against a so-called raid boss (raid boss battle).

Further, timing when the acquiring section 101 acquires the image regarding the progress of the video game is not particularly limited. However, it is preferable to be timing when the player can be attracted. Examples of the timing when the acquiring section 101 acquires an image include timing when a request to acquire an image by the player is received.

The image synthesizing section 16D has a function to synthesize, when the acquiring section 101 acquires the image regarding the progress of the video game, the image and the image generated by the image generating section 14 to generate a synthesized image.

The notifying section 102 has a function to notify the progress control server of an operation of a player when the receiving section 12 receives a control signal containing the operation of the player with respect to the image acquired by the acquiring section 101.

Here, a configuration to notify an operation of a player is not particularly limited. Examples of the configuration include a method of transferring the received control signal as it is to the progress control server and a method of changing or transferring the received control signal after a part of the received control signal is deleted.

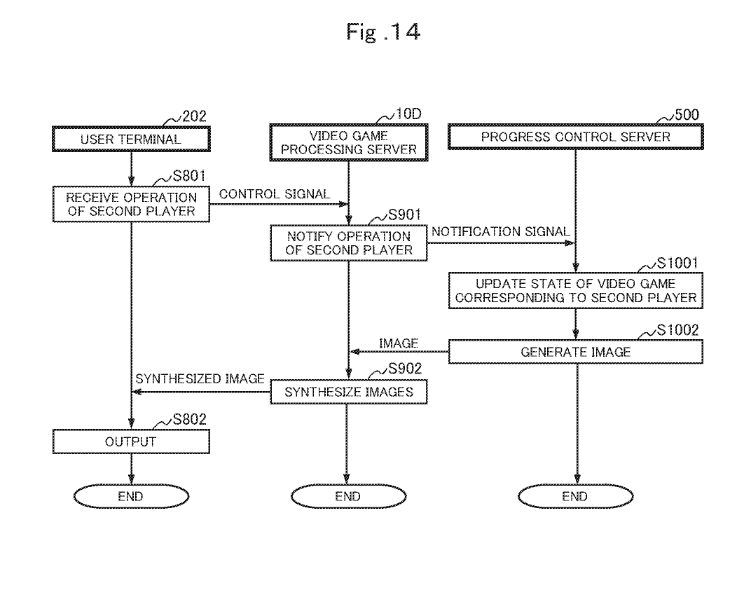

FIG. 14 is a flowchart showing an example of game processing carried out by the system 100. In the game processing according to the present embodiment, processing directly or indirectly related to a fact that the server 10D acquires an image from a progress control server 500 (not shown in the drawings) is carried out. Hereinafter, a case where a terminal of the second player is a user terminal 202 (the terminal 202) will be described as an example.

The game processing is started in a case where the terminal 202 receives, from the second player, a request to start the video game whose progress is controlled by the progress control server 500, for example. Hereinafter, a case where the progress control server 500 appropriately controls progress a so-called “raid boss battle” will be described as an example.

In the game processing, the terminal 202 first receives an operation of the second player (Step S801). In the present embodiment, the terminal 202 transmits a control signal according to the received operation to the server 10D.

When the control signal transmitted by the terminal 202 is received, the server 10D notifies the progress control server 500 of the operation of the second player on the basis of the received control signal (Step S901).

When the notification by the server 10D is received, the progress control server 500 updates the state of the video game corresponding to the second player on the basis of the received notification (Step S1001). In the present embodiment, the progress control server 500 in advance acquires information regarding the second player from the server 10D, and updates, on the basis of the information and the content of the received notification, the state of the video game whose progress is controlled. In this regard, a target updated by the progress control server 500 at this time is not particularly limited. An example of the updated target includes a status of a raid boss.

When the state of the video game is updated, the progress control server 500 generates an image corresponding to the updated state of the video game (Step S1002). In the present embodiment, the progress control server 500 transmits the generated image to the server 10D, and terminates the processing herein.

When the image transmitted by the progress control server 500 is received, the server 10D generates a synthesized image using the received image and the image generated by the server 10D (Step S902). In the present embodiment, the server 10D synthesizes the image of the video game whose progress is controlled by the server 10D and the image of the video game whose progress is controlled by the progress control server 500; transmits the synthesized image to the terminal 202; and terminates the processing herein.

When the synthesized image transmitted by the server 10D is received, the terminal 202 outputs the received synthesized image (Step S802), and terminates the processing herein.

As explained above, as one side of the fourth embodiment, the image generating apparatus (for example, the server 10D) is configured so as to: include the storage section 11, the receiving section 12, the updating section 13C, the image generating section 14C, the extracting section 15, the image synthesizing section 16D, the transmitting section 17, the acquiring section 101 and the notifying section 102; acquire an image regarding the video game from a server configured to control progress of the video game associated with the first player and the second player (for example, the progress control server 500), the image being associated with the second player; and generate a synthesized image by using the acquired image regarding the progress of the video game and the generated image (for example, Step S902). Therefore, it is possible to provide a common image even in a case where the first player and the second player are respectively positioned in different virtual spaces.

Namely, for example, in a case where a so-called raid boss system is adopted, it is possible to realize a system capable of providing, to a user terminal, an image obtained by synthesizing an image corresponding to a virtual space in which a player is positioned and an image of a virtual space in which a raid boss is positioned (an raid boss space image), whereby each of players can share the raid boss space image.

Further, in the example of the fourth embodiment described above, the image generating apparatus (for example, the server 10D) is configured so as to: notify the server (for example, the progress control server 500) of the operation of the player when the control signal containing the operation of the player with respect to the acquired image is received (for example, Step S901); and acquire the updated image regarding the video game from the server on the basis of the operation of the player. Therefore, it is possible to realize a system in which the plurality of players each of which causes the video game to proceed independently of each other can share progress of the same video game easily. Namely, it is possible to realize a system in which some influence can be applied to the raid boss in a case where each player takes an action with respect to a raid boss space shared with other players, for example.

In this regard, a configuration to receive an action of the player with respect to the raid boss space is not particularly limited. It may be a configuration in which it is possible to recognize an intention of the player in the server 10D. Examples of the configuration to receive an action include a configuration in which it is determined that an action against a raid boss space is received in a case where the server 10D receives a touch operation with respect to a region in which the raid boss space is displayed or an operation to specify a predetermined command.

In this regard, although it has not been particularly mentioned in the example of the fourth embodiment described above, a display mode of the synthesized image in the user terminal is not particularly limited. The display mode may be a mode by which the user can recognize existence of two types of images. Examples of the display mode of the synthesized image include a mode to display two types of images by superimposing one image on the other image, and a mode to display two types of image at a predetermined position in the whole screen.

### Fifth Embodiment

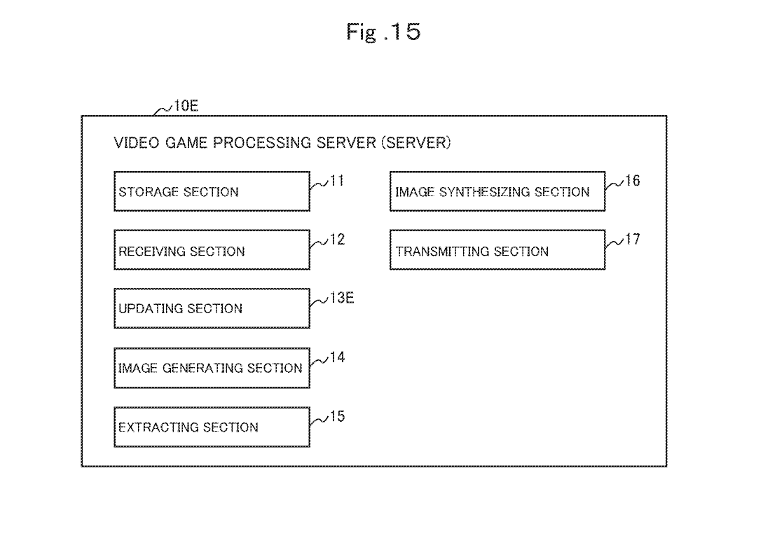

FIG. 15 is a block diagram showing a configuration of a video game processing server 10E (hereinafter, referred to as the “server 10E”) that is an example of the video game processing server 10 according to one of the embodiments of the present invention. The server 10E includes at least a storage section 11, a receiving section 12, an updating section 13E, an image generating section 14, an extracting section 15, an image synthesizing section 16, and a transmitting section 17.

The updating section 13E has a function to update a state of a video game within a virtual space on the basis of a control signal for a terminal of a second player. An avatar stored in the storage section 11 and operated by a first player exists in the virtual space. The control signal is received by the receiving section 12.

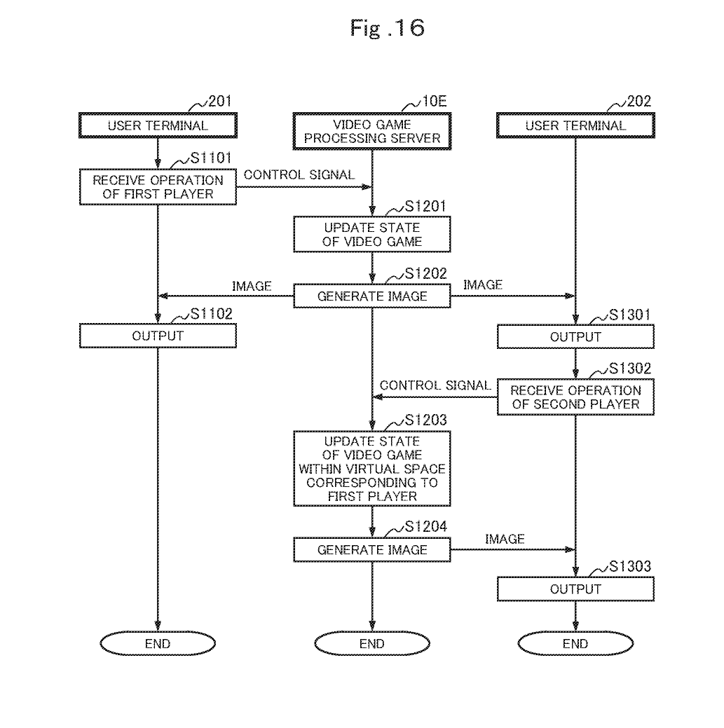

FIG. 16 is a flowchart showing an example of game processing carried out by the system 100. In the game processing according to the present embodiment, processing in which the server 10E updates the state of the video game for the first player in accordance with an operation of the second player; generates an image; and outputs the image to a user terminal operated by the second player is carried out. Hereinafter, a case where a terminal of the first player is a user terminal 201 (terminal 201) and a terminal of the second player is a user the terminal 202 (terminal 202) will be described as an example.

The game processing is started in a case where the terminal 201 and the terminal 202 are associated with the server 10E, for example. Hereinafter, a case where the server 10E associates the terminal 201 with the terminal 202 will be described as an example.

In the game processing, the terminal 201 first receives an operation of the first player (Step S1101). In the present embodiment, the terminal 201 transmits a control signal according to the received operation to the server 10E.

When the control signal transmitted by the terminal 201 is received, the server 10E updates the state of the video game on the basis of the received control signal (Step S1201).

When the state of the video game is updated, the server 10E generates an image corresponding to the updated state of the video game (Step S1202). In the present embodiment, the server 10E generates an image indicating the virtual space in which the first player is positioned, and transmits the generated image to the terminal 201. Further, the server 10E synthesizes the generated image to the image indicating the virtual space in which the second player is positioned, and transmits the synthesized image to the terminal 202.

When the image transmitted by the server 10E is received, the terminal 201 outputs the received image (Step S1102), and terminates the processing herein.

On the other hand, when the image transmitted from the server 10E is received, the terminal 202 outputs the received image (Step S1301).

When the received image is outputted, the terminal 202 receives an operation of the second player (Step S1302). In the present embodiment, the terminal 202 receives an operation with respect to the virtual space in which the first player is positioned, and transmits a control signal containing the content of the received operation to the server 10E.

When the control signal transmitted by the terminal 202 is received, the server 10E updates the state of the video game on the basis of the received control signal (Step S1203). In the present embodiment, the server 10E updates, in accordance with the operation of the second player, the state of the video game in the virtual space corresponding to the first player.

When the state of the video game is updated, the server 10E generates an image to be transmitted to the terminal of the second player on the basis of the updated state of the video game (Step S1204). In the present embodiment, the server 10E transmits data corresponding to the generated image to the terminal 202. Namely, the server 10E generates, on the basis of the updated state of the video game, an image indicating the virtual space in which the first player is positioned. Then, the server 10E synthesizes the generated image to the image indicating the virtual space in which the second player is positioned, and transmits data corresponding to the synthesized image to the terminal 202. Here, a configuration of the data corresponding to the image is not particularly limited. The configuration may be a configuration in which the image can be displayed on the display screen of the display device included in the terminal 202.

When the image transmitted by the server 10E is received, the terminal 202 outputs the received image (Step S1303), and terminates the processing herein.

As explained above, as one side of the fifth embodiment, the image generating apparatus (for example, the server 10E) is configured so as to: include the storage section 11, the receiving section 12, the updating section 13E, the image generating section 14, the extracting section 15, the image synthesizing section 16 and the transmitting section 17; store the image to be transmitted to the terminal controlled by the first player (for example, the terminal 201) and the positional information in the virtual space in which the avatar operated by the first player exists; receive the control signal for the terminal of the second player; update the state of the video game in the virtual space in which the avatar operated by the first player on the basis of the control signal (for example, Step S1203); generate an image to be transmitted to the terminal of the second player on the basis of the updated state of the video game (for example, Step S1204); and transmit data corresponding to the generated image to the terminal of the second player. Therefore, it is possible to realize a system in which a third party who browses (or views) the image obtained by synthesizing images of other player can influence on the other player.

In this regard, it has not been particularly mentioned in the example of the fifth embodiment described above. However, the condition that the image generating apparatus (for example, the server 10E) causes the plurality of terminals to be associated with each other is not particularly limited. Examples of the condition include a condition that is satisfied in accordance with progress of the video game and a condition that is satisfied by specification of other player by the player.

In this regard, it has not been particularly mentioned in the example of the fifth embodiment described above. However, when to update the state of the video game in the virtual space corresponding to the first player in accordance with the operation of the second player, the update content is not particularly limited. Examples of the update in the state of the video game by the operation of the second player include update regarding support or cooperation, obstruction and the like for the first player by the second player. Further, examples of the update in the state of the video game regarding cooperation include display of a comment inputted by the second player, and provision of an item in the video game to the first player by the second player. Further, examples of the update in the state of the video game regarding obstruction include recovery or reinforcement to an enemy character. Further, the image generating apparatus (for example, the server 10E) may be configured so as to provide the identification information of the second player to the first player.

In this regard, it has not been particularly mentioned in the example of the fifth embodiment described above. However, the image generating apparatus (for example, the server 10E) may be configured so as to determine that a control signal transmitted from a terminal of a player who satisfies a predetermined condition of players for whom his or her avatar does not exist in the same virtual space as that for the avatar operated by the first player is set to a control signal of the terminal of the second player. By configuring the image generating apparatus in this manner, it is possible to restrict players who can influence on other player. In this regard, the condition as the same virtual space is not particularly limit. The virtual space may be a virtual space that satisfies a condition defined in advance for the virtual space in which the avatar operated by the first player is position (for example, virtual spaces managed by the same server).

In this regard, it has not been particularly mentioned in the example of the fifth embodiment described above. However, the image generating apparatus (for example, the server 10E) may be configured so as to determine that a player who does not have his or her avatar is set to the second player. By configuring the image generating apparatus in this manner, it is possible to restrict players who can influence on other player. In this regard, a condition (unowned condition) as the player who does not have his or her avatar is not particularly limited. Examples of the unowned condition include a condition that the player is a player whose avatar is not registered, and a condition that the player is a player whose avatar has been registered but his or her avatar is not set to an operatable state.

### Sixth Embodiment

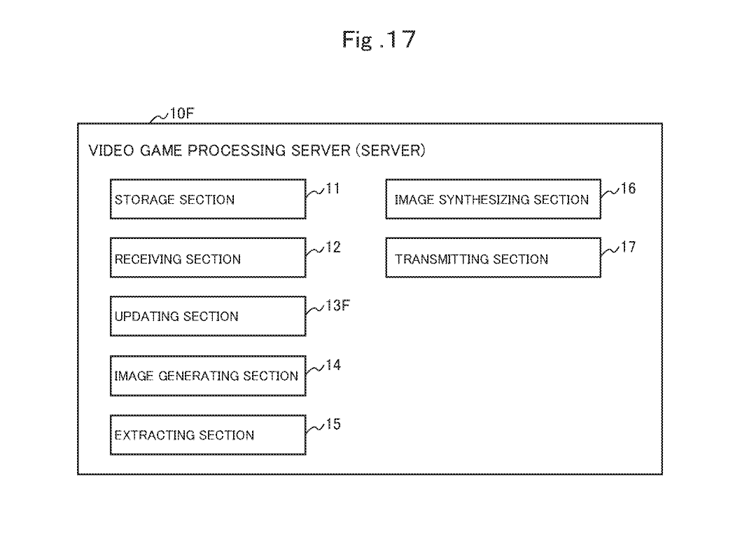

FIG. 17 is a block diagram showing an example of a video game processing server 10F (hereinafter, referred to as the “server 10F”), which is an example of the video game processing server 10 according to one of the embodiments of the present invention. The server 10F includes at least a storage section 11, a receiving section 12, an updating section 13F, an image generating section 14, an extracting section 15, an image synthesizing section 16, and a transmitting section 17.

The updating section 13F has a function to update a state of a video game related to at least any of a status of an avatar operated by a first player and an object that exists in a virtual space. In this regard, an example of the status of the avatar operated by the first player includes money in its possession, an HP, and an offensive power. Further, the objects that exist in the virtual space include images corresponding to an avatar or an NPC operated by the player, a virtual construction (structure), selection key and the like.

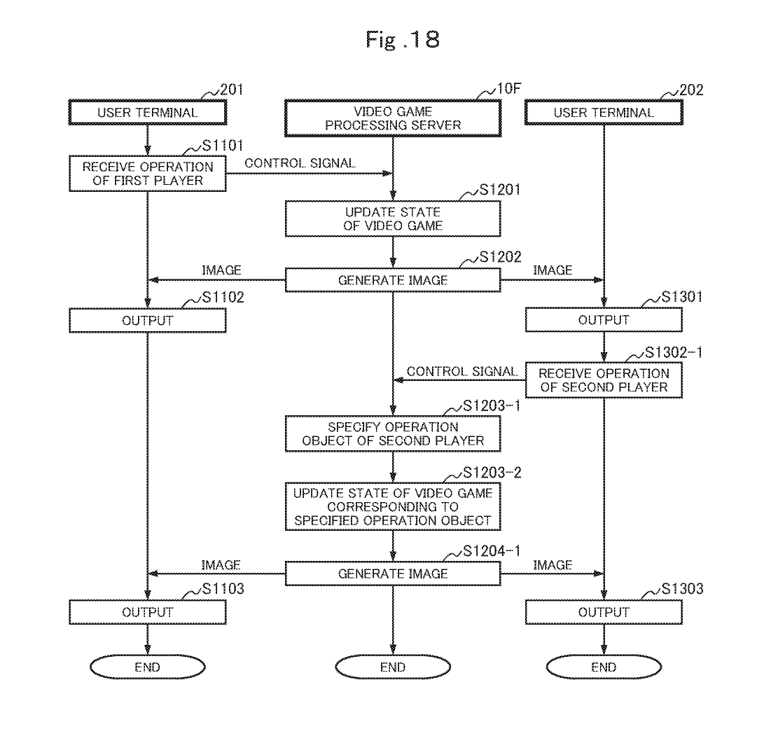

FIG. 18 is a flowchart showing an example of the game processing carried out by the system 100. In the game processing according to the present embodiment, processing in which the server 10F updates the state of the video game of the first player in accordance with an operation of the second player, generates an image and outputs the image to the user terminals respectively operated by the first player and the second player is carried out. Hereinafter, portions deferent from the example of the fifth embodiment (see FIG. 16) will be described.

In the game processing, when the image transmitted by the server 10F is outputted (Step S1301), the terminal 202 receives an operation of the second player (Step S1302-1). In the present embodiment, the terminal 202 outputs an image obtained by synthesizing an image indicating a virtual space in which the first player is positioned and an image indicating a virtual space in which the second player is positioned, and receives a touch operation by the second player. The terminal 202 then transmits a control signal containing the content of the touch operation to the server 10F.

Here, examples of the content of the touch operation include one that influences on the status of the avatar operated by the first player (for example, an item applying operation) and identification information of the object displayed at a touch position (i.e., a selection indicating operation of the object by the first player). Hereinafter, a case where the terminal 202 receives a touch operation to an object contained in an image indicating a virtual space in which the first player is positioned will be described as an example.

When the control signal transmitted by the terminal 202 is received, the server 10F specifies a target operated by the second player on the basis of the received control signal (Step S1203-1). In the present embodiment, the server 10F identifies an object corresponding to the touch operation on the basis of the control signal, and specifies the identified object as a target operated by the second player.

When the target operated by the second player is specified, the server 10F updates the state of the video game corresponding to the specified operated target (Step S1203-2). In the present embodiment, the server 10F carries out processing associated with each object in advance, thereby updating the state of the video game. Here, the content of the processing associated in advance is not particularly limited. However, it is preferable that the content of the processing associated in advance is content related to the object. Examples of the content of the processing associated in advance include movement of an object, an increase or decrease in the number of objects, a change in a display form, and fulfillment of a function as a selection key.

When the state of the video game is updated, the server 10F generates, on the basis of the updated state of the video game, an image to be transmitted to the terminal of the second player (Step S1204). In the present embodiment, the server 10F first generates, on the basis of the updated state of the video game, an image indicating a virtual space in which the first player is positioned. Subsequently, the server 10F synthesizes the generated image and an image indicating a virtual space in which the second player is positioned. The server 10F then transmits the generated image to the terminal 201, and transmits the synthesized image to the terminal 202.

When the image transmitted by the server 10F is received, the terminal 201 outputs the received image (Step S1103), and terminates the processing herein. Further, when the image transmitted by the server 10F is received, the terminal 202 outputs the received image (Step S1303), and terminates the processing herein.

As explained above, as one aspect of the sixth embodiment, the image generating apparatus (for example, the server 10F) is configured so as to include the storage section 11, the receiving section 12, the updating section 13F, the image generating section 14, the extracting section 15, the image synthesizing section 16 and the transmitting section 17; and so that the state of the video game updated by the updating section 13F contains a state related to at least any of the status of the avatar operated by the first player and the object that exists in the virtual space. Therefore, it is possible to transfer information to third parties easily, and this makes it possible to realize a system in which third parties use information so as to be capable of influencing on other player easily.

### Seventh Embodiment

The image generating apparatus according to each of the first to sixth embodiments described above (for example, the video game processing server 10) has a function to generate an image in accordance with progress of a video game as explained below.

In this regard, the word “in accordance with progress of a video game” means that occurrence of any of various kinds of progress or changes, which can occur in a video game, becomes an opportunity or standard of specific processing. As an example of the specific processing, determination processing is thought, for example. Further, as examples of the various kinds of progress or changes that can occur in the video game, progress of time, a change in an element value of the video game, update of a specific status or flag, or an operational input by a user are thought.

Hereinafter, an outline of an example of the video game corresponding to at least one of the embodiments according to the present invention will be described.

The video game has a theme of “per person MMORPG for connecting to others in a loose manner”. In particular, the video game has a theme of a third-person and 3D-action RPG subject to a so-called cloud gaming.

Target hardware of the video game is a so-called smart phone or a tablet (a video game console). Subject to an overwhelming computing power and drawing power, and a constant online connection environment of a server, it is an object to realize a “simple communication technique linked to a billing axis”, “gentle cooperation play”, and a “video game world in which connection with other player can be seen”. Hereinafter, specification of each of themes will be explained.

First, in order to realize the “simple communication technique linked to a billing axis”, in the video game, communication means only for praising someone is implemented. As an example of the communication means, means for applying a point or privilege to a praised player is thought.

The communication means only in the video game is a “like button”. By pressing the “like button”, it is possible to “praise” someone. In other words, pressing of the “like button” can only praise someone. By helping a person and being praised by the helped person, it is possible to get a point. This makes it possible to promote support between users with each other. A simple mechanism allows to remove or reduce necessity of the users who become aware of differences of countries and/or languages.

Next, in order to realize the “gentle cooperation play”, in the video game, a quest whose difficulty degree is set to high (for example, death from a fall that is not to be helped, death against a boss that is seen for the first time with a wide margin) and required to be “supported” by other player is implemented. Moreover, a quest cleared method is adopted for the quest, and a method in which an attack can proceed by a party to which a rental NPC from other player is added is implemented.

In the video game, the plurality of players not only carries out directly cooperation play, but also cooperates with other player to carry out “support” play. As an example of a flow of the support play, a player who is to be dying by a boss battle first requests to help the player to other player. Next, a window is displayed in a field of the other player. Then, when the other player carries out an action against the displayed window, an effect is reflected to the player. As an example of the effect, it is thought an effect that, in a case where a character with superhuman strength carries out an action to grasp and shake the window, all of characters displayed on a screen of the player lose a balance to make a chance. Namely, the window not only displays an image or video, but also becomes a window for interferes in the other player. This causes a support action to have a game element, and this is conductive to evaluation of the “like button”.

Further, in the video game, the player units a party to cause a quest to proceed. Each player can use an NPC monster that has been grown by other player in addition to his or her own NPC monster. As points of the NPC rental for the cooperation play, there are a point that “by renting an NPC, a skill and AI grow (a growth efficiency is better than that of his or her own party)”, a point that “by renting other NPC monster suitable for a quest attack and then starting the quest, it becomes easy to win”, a point that “other NPC monster selects a candidate at random, and a strong monster is to be chosen for a player who is killed many times” and a point that “the “like button” can be selected when the quest is terminated”.

Finally, in order to realize the “video game world in which connection with other player can be seen”, in the video game, means for providing a new connection to other users with innovative graphic for streaming a status of a plurality of other players by utilizing a server power is implemented.

In the video game, a plurality of streaming videos that a plurality of other players plays is implemented. Namely, for example, during movement of a field, many windows are opened and a status of each of the other players is reproduce by streaming (see FIG. 7). This allows to develop a cloud gaming own screen graphic that is unprecedented. Further, in the video game according to the present embodiment, it is possible to browse an image (or video) in detail by enlarging the window.

Further, in the video game according to the present embodiment, confirmation of play of other player becomes means for attack or win.

A status of other player who plays the video game around the player in real time is displayed in the window. In particular, in the video game, a past play log of the player who carries out a specific action (dead, get an item, or the like) in the area is reproduced as a play movie. In this regard, the word “around the player” means that an actual distance is within a predetermined distance or that a distance in the virtual space is within the predetermined distance.

Further, in the video game, it means that the more the number of displayed windows is, the higher a possibility of danger becomes.

As described above, in the video game, the image or video of the window connects the players to each other.

In this regard, a video game world that can be changed by players is realized in the video game. Namely, a field indicating the virtual space is changed by means of play of each of the players. More specifically, on the basis of tracks through which other players pass, the image is modified, and the modified image is displayed. By configuring the image generating apparatus in this manner, for example, a lot of players passes so as to avoid a place where a strong enemy exists, and stop a place where an item can be obtained. Thus, a road is made in the field, and this helps an attack of each of the following players. Further, as another example, in a case where a player plants a tree that yields a recovery item, it may be configured so that other player can utilize the tree. This makes it possible to give variety to relation or connection between players.

As explained above, one or two or more shortages are solved by each of the embodiments of the present application. In this regard, the effects by each of the embodiments are non-limiting effects or one example of effects.

In this regard, it has not been particularly mentioned in each of the embodiments described above. However, the image generating apparatus (for example, the video game processing server 10) may be configured so as to: when identification information of an already-generated image is received from the terminal of the second player, search the already-generated image on the basis of the identification information; synthesize the generated image and the searched image; and generate a synthesized image. Namely, the image generating apparatus may be configured so as to: receive an input of a search word from a player; search videos managed on a video sharing site using the received search word; synthesize the searched video and the image according to the progress of the video game; and generate the synthesized image. By configuring the image generating apparatus in this manner, it is possible to variegate a providing form of information.

In this regard, in each of the embodiments described above, each of the plurality of user terminals 20 and 201 to 20N and the video game processing server 10 carries out the various kinds of processing described above in accordance with various kinds of control programs (for example, a video game processing program) stored in the storage device with which the corresponding terminal or server is provided.

In this regard, the configuration of the video game processing system 100 is not limited to the configuration that has been explained as the example of the respective embodiments described above. For example, it may be configured so that part or all of the processing that has been explained as the processing carried out by the user terminal is carried out by the server 10, or it may be configured so that part or all of the processing that has been explained as the processing carried out by the server 10 is carried out by any of the plurality of user terminals 20 and 201 to 20N (for example, the user terminal 201). Further, it may be configured so that a part or all of the storage sections included by the server 10 is included in any of the user terminals 20 and 201 to 20N. Namely, it may be configured so that a part or all of the functions included in any one of the user terminal 201 and the video game processing server 10 according to the video game processing system 100 is included in the other.

Examples of the configuration in which any of the plurality of user terminals 20 and 201 to 20N include a part of the functions included in the video game processing server 10 include a configuration in which an image is generated at the user terminal side. Namely, for example, with respect to the example that has been explained with reference to FIG. 16, the terminal 201 or the terminal 202 may be configured so as to: receive information regarding the update of the state of the video game generated by the server 10E; and generate an image on the basis of the received information. By causing a user terminal provided with a rendering function and the like to carry out processing regarding generation of the image, it is possible to reduce a processing load on the video game processing server 10.

Further, the video game processing program may be configured so as to cause a single apparatus that does not include a communication network to realize a part or all of the functions, which have been explained as the examples of the respective embodiments described above.

### APPENDIX

The explanation of the embodiments described above has been described so that the following inventions can be at least realized by a person having a normal skill in the art to which the present invention belongs.

(1)

An image generating apparatus, including:

a storage section configured to store an image and positional information so as to be associated with each other, the image being to be transmitted to a terminal controlled by a first player, the positional information being information regarding a position within a virtual space in which an avatar operated by the first player exists;

a receiving section configured to receive a control signal for a terminal of a second player;

an updating section configured to update a state of a video game on the basis of the control signal;

an image generating section configured to generate, on the basis of the state of the video game updated by the updating section, an image to be transmitted to the terminal of the second player;

an extracting section configured to extract an image related to a position of the avatar operated by the second player in the virtual space from the storage section on the basis of the positional information;

an image synthesizing section configured to synthesize the image generated by the image generating section and the image extracted by the extracting section to generate a synthesized image; and

a transmitting section configured to transmit data corresponding to the synthesized image to the terminal of the second player.

(2)

The image generating apparatus according to (1),

wherein the storage section stores the image to be transmitted to the terminal controlled by the first player substantially at the same time as timing when the receiving section receives the control signal.

(3)

The image generating apparatus according to (1),

wherein the storage section stores the image to be transmitted to the terminal controlled by the first player before the receiving section receives the control signal.

(4)

The image generating apparatus according to (1),

wherein the storage section stores the image to be transmitted to the terminal controlled by the first player when specific information is associated with identification information of the first player.

(5)

The image generating apparatus according to (1),

wherein the extracting section stores the image to be transmitted to the terminal controlled by the first player when the state of the video game corresponding to the first player becomes a predetermined status.

(6)

The image generating apparatus according to (1),

wherein the positional information is identification information indicating coordinates of the virtual space or a predetermined region in the virtual space.

(7)

An image generating apparatus, including:

a storage section configured to store an image to be transmitted to a terminal controlled by a first player;

a receiving section configured to receive a control signal for a terminal of a second player;

an updating section configured to update a state of a video game on the basis of the control signal;

an image generating section configured to generate an image to be transmitted to the terminal of the second player on the basis of the state of the video game updated by the updating section;

an extracting section configured to extract the image to be transmitted to the terminal controlled by the first player from the storage section;

an image synthesizing section configured to insert an image constituting the image extracted by the extracting section into a region of at least a part of at least one image constituting the image generated by the image generating section to generate a synthesized image; and

a transmitting section configured to transmit data corresponding to the synthesized image to the terminal of the second player.

(8)

The image generating apparatus according to (7),

wherein the receiving section receive an image control signal from the terminal of the second player, and

wherein the image synthesizing section changes an attitude of the image to be inserted on the basis of the image control signal.

(9)

The image generating apparatus according to (8),

wherein the attitude is a display size of the image to be inserted or a position of the part of the region on the one image.

(10)

The image generating apparatus according to (9),

wherein the receiving section receives the image control signal from the terminal of the second player, and

wherein the image synthesizing section stops the insertion of the image on the basis of the image control signal.

(11)

The image generating apparatus according to (7),

wherein the image synthesizing section superimposes an image constituting the image extracted by the extracting section onto at least the part of the region of at least one image constituting the image generated by the image generating section.

(12)

The image generating apparatus according to (1),

wherein, in a case where the control signal contains a signal indicating an operation of the second player with respect to the image extracted by the extracting section, the updating section updates the state of the video game so that the position of the avatar operated by the second player becomes a position related to the position in the virtual space in which the avatar operated by the first player exists.

(13)

The image generating apparatus according to (12),

wherein the operation of the player includes a touch operation with respect to a display region of the image extracted by the extracting section and displayed in the terminal of the second player.

(14)

The image generating apparatus according to (12), further including:

a communicating section configured to communicate with each of a plurality of servers respectively corresponding to a plurality of areas constituting the video game; and

a specifying section configured to specify an area corresponding to the state of the video game updated by the updating section,

wherein the communicating section communicates a server corresponding to the area specified by the specifying section, and

wherein the image generating section generates the image to be transmitted to the terminal of the second player using data contained in a communication result by the communicating section.

(15)

The image generating apparatus according to (1) or (7), further comprising:

an acquiring section configured to acquire an image regarding the video game associated with the second player from a server for controlling progress of the video game associated with the first player and the second player,

wherein the image synthesizing section generates the synthesized image by using an image regarding progress of the video game acquired by the acquiring section and the image generated by the image generating section.

(16)

The image generating apparatus according to (15), further including:

a notifying section configured to notify the server of an operation of the player when the receiving section receives the control signal containing the operation of the player with respect to the image acquired by the acquiring section,

wherein the acquiring section acquires an image regarding the video game updated on the basis of the operation of the player from the server.

(17)

An image generating apparatus, including:

a storage section configured to store an image and positional information, the image being to be transmitted to a terminal controlled by a first player, the positional information being information regarding a position within a virtual space in which an avatar operated by the first player exists;

a receiving section configured to receive a control signal for a terminal of a second player;

an updating section configured to update, on the basis of the control signal, a state of a video game in the virtual space in which the avatar operated by the first player, the state of the video game being stored in the storage section;

an image generating section configured to generate, on the basis of a state of the video game updated by the updating section, an image to be transmitted to the terminal of the second player; and

a transmitting section configured to transmit data to the terminal of the second player, the data corresponding to the image generated by the image generating section.

(18)

The image generating apparatus according to (17),

wherein the state of the video game updated by the updating section contains a state related to at least any of a status of the avatar operated by the first player and an object that exists in the virtual space.

(19)

The image generating apparatus according to (17),

wherein the receiving section determines that the control signal transmitted from a terminal of a player who satisfies a predetermined condition of players who do not have their own avatar in the same virtual space as that of the avatar operated by the first player is the control signal for the terminal of the second player.

(20)

The image generating apparatus according to (17),

wherein the receiving section determines that a player who does not have his or her own avatar is the second player.

(21)

The image generating apparatus according to (1) or (7), further including:

a searching section configured to search an already-generated image on the basis of the identification information when identification information of the already-generated image is received from the terminal of the second player,

wherein the image generating section synthesizes the image generated by the image generating section and the image searched by the searching section to generate a synthesized image.

(22)

A program for causing a computer to realize:

a storing function configured to store, in a predetermined storage region, an image to be transmitted to a terminal controlled by a first player and positional information within a virtual space in which an avatar operated by the first player exists so as to be associated with each other;

a receiving function configured to receive a control signal for a terminal of a second player;

an updating function configured to update a state of a video game on the basis of the control signal;

an image generating function configured to generate an image to be transmitted to the terminal of the second player on the basis of the state of the video game updated by the updating function;

an extracting function configured to extract an image related to a position of an avatar operated by the second player in the virtual space from the predetermined storage region on the basis of the positional information;

an image synthesizing function configured to synthesize the image generated by the image generating function and the image extracted by the extracting function to generate a synthesized image; and

a transmitting function configured to transmit data corresponding to the synthesized image to the terminal of the second player.

(23)

A program for causing a computer to realize:

a storing function configured to store an image to be transmitted to a terminal controlled by a first player in a predetermined storage region;

a receiving function configured to receive a control signal for a terminal of a second player;

an updating function configured to update a state of a video game on the basis of the control signal;

an image generating function configured to generate an image to be transmitted to the terminal of the second player on the basis of the state of the video game updated by the updating function;

an extracting function configured to extract the image to be transmitted to the terminal controlled by the first player from the predetermined storage region;

an image synthesizing function configured to insert an image constituting the image extracted by the extracting function into at least a part of a region of at least one image constituting the image generated by the image generating function to generate a synthesized image; and

a transmitting function configured to transmit data corresponding to the synthesized image to the terminal of the second player.

(24)

A program for causing a computer to realize:

a storing function configured to store an image to be transmitted to a terminal controlled by a first player and positional information within a virtual space in a predetermined storage region so that the image and the positional information are associated with each other, an avatar operated by the first player existing in the virtual space;

a receiving function configured to receive a control signal for a terminal of a second player;

an updating function configured to update, on the basis of the control signal, the state of the video game in the virtual space in which the avatar operated by the first player and stored in the predetermined storage region;

an image generating function configured to generate, on the basis of the state of the video game updated by the updating function, an image to be transmitted to the terminal of the second player; and

a transmitting function configured to transmit data to the terminal of the second player, the data corresponding to the image generated by the image generating function.

(25)

A terminal configured to communicate with the image generating apparatus according to (17), the terminal including:

means for operating as the terminal controlled by the first player or the terminal controlled by the second player.

(26)

An image generating system including a communication network, a server, a terminal controlled by a first player, and a terminal controlled by a second player, the image generating system including:

a storage section configured to store an image to be transmitted to the terminal controlled by the first player and positional information within a virtual space in which an avatar operated by the first player exists;

a receiving section configured to receive a control signal of the terminal of the second player;

an updating section configured to update, on the basis of the control signal, a state of a video game in the virtual space in which the avatar operated by the first player and stored in the storage section exists;

an image generating section configured to generate, on the basis of the state of the video game updated by the updating section, an image to be transmitted to the terminal of the second player; and

a transmitting section configured to transmit data to the terminal of the second player, the data corresponding to the image generated by the image generating section.

### INDUSTRIAL APPLICABILITY

According to one of the embodiments of the present invention, it is useful to provide means capable of transferring information to third parties easily.

### DESCRIPTION OF REFERENCE NUMERALS

10 video game processing server
11 storage section
12 receiving section
13 updating section
14 image generating section
15 extracting section
16 image synthesizing section
17 transmitting section
18 communicating section
19 specifying section
20, 201 to 20N user terminal
30 communication network
100 video game processing system
101 acquiring section
102 notifying section

1. An image generating apparatus, comprising:
a storage configured to store an image and positional information, the image being to be transmitted to a terminal controlled by a first player, the positional information being information regarding a position within a virtual space in which an avatar operated by the first player exists;
a receiver configured to receive a control signal for a terminal of a second player;
a controller configured to update, on the basis of the control signal, a state of a video game in the virtual space in which the avatar is operated by the first player, the state of the video game being stored in the storage;
an image generator configured to generate, on the basis of the state of the video game updated by the controller, an image to be transmitted to the terminal of the second player; and
a transmitter configured to transmit data to the terminal of the second player, the data corresponding to the image generated by the image generator.

2. The image generating apparatus according to claim 1,
wherein the state of the video game updated by the controller contains a state related to at least any of a status of the avatar operated by the first player and an object that exists in the virtual space.

3. A non-transitory computer-readable medium including a program for causing a computer to perform operations including:
storing an image to be transmitted to a terminal controlled by a first player and positional information within a virtual space in a predetermined storage so that the image and the positional information are associated with each other, an avatar operated by the first player existing in the virtual space;
receiving a control signal for a terminal of a second player;
updating, on the basis of the control signal, the state of the video game in the virtual space in which the avatar is operated by the first player, the state of the video game being stored in the predetermined storage;
generating, on the basis of the state of the video game updated by the updating of the state of the video game, an image to be transmitted to the terminal of the second player; and
transmitting data to the terminal of the second player, the data corresponding to the image generated by the generating of the image.

4. A terminal configured to communicate with the image generating apparatus according to claim 1, wherein
the terminal is configured to be operated as the terminal controlled by the first player or the terminal controlled by the second player.

5. An image generating system including a communication network, a server, a terminal controlled by a first player, and a terminal controlled by a second player, the image generating system comprising:
a storage configured to store an image to be transmitted to the terminal controlled by the first player and positional information within a virtual space in which an avatar operated by the first player exists;
a receiver configured to receive a control signal of the terminal of the second player;
a controller configured to update, on the basis of the control signal, a state of a video game in the virtual space in which the avatar is operated by the first player, the state of the video game being stored in the storage;
an image generator configured to generate, on the basis of the state of the video game updated by the controller, an image to be transmitted to the terminal of the second player; and
a transmitter configured to transmit data to the terminal of the second player, the data corresponding to the image generated by the image generator.
